(19) United States
(12) Patent Application Publication
(10) Pub. No.: US 2005/0125500 A1
(43) Pub. Date: Jun. 9, 2005

(54) Instant messenger(s) extension and system thereof

(76) Inventor: Winfred W. Wu, Taipei City (TW)

Correspondence Address: RUBEN C. DELEON;WINSTEAD SECHROST & MINICK P.C., P.O. BOX 50784, DALLAS, TX, 75201, US

(21) Appl. No.: 10/730,455

(22) Filed: Dec. 8, 2003

(51) Int. Cl. G06F 15/16; H04Q 11/00; H04M 3/42; H04L 12/16

(52) U.S. Cl. 709/207; 379/202.01; 370/260

(57) ABSTRACT

Disclosed is an instant messenger extension. The instant messenger extension includes a message monitor to filter the messages of nowadays instant messengers. For providing an interface extension of a communication apparatus, messages exchanging extends between the communication and remote instant messengers via the local instant messengers. The communication apparatus can further communicate with other remote communication apparatuses to providing them to exchange messages by the communication between instant messengers. Thus, the usage of the instant messengers can be unattended and ambiguous.

### BACKGROUND OF THE PRESENT INVENTION

1. Field of the Invention

The invention relates to a network communication, and more particularly, to a communication coupled with instant messengers and the communication apparatuses.

2. Description of the Prior Art

Instant messengers can be used to provide the service of information exchanging. By forming all kinds of information into messages, the communication for exchanging messages can be mad by instant messengers. Kinds of instant messengers have been published already, such as windows messenger, MSN messenger, Yahoo Messenger, AIM, ICQ or the like. The foregoing messages can be electrical signals, strings, files, sounds, pictures, images and so on. Messages may be transmitted peer to peer, or be forwarded via a server. Thus, the messages transmission of instant messengers mentioned in the following description comprises the two transmission ways. Referring to FIG. 1A, an instant messenger 12 running on a computer 14 can be registered with an identification 102 by a user, then the identification is online. Each online identification 102 can exchange messages with other identifications 102 in its contact buddy 104, as long as the others are online, too.

However, an instant messenger can only exchange messages with instant messenger published by the same vendor. For example, a first instant messenger and a second instant messenger are running on a computer, and they are different types. Each of them can exchange messages with the same instant messengers running on many different computers. Referring to FIG. 1B, a computer 14 can execute kinds of instant messengers 12, and each kind of instant messenger 12 exchanges messages with the same instant messengers 12. The messages can not only contain text messages, but also contain sound messages and video messages.

Because different instant messengers are not compatible, some cross instant messengers software with integrated interface are designed. Most of them can be used for exchanging messages contained text messages. Besides, message contents of individual instant messengers are displayed on a common graphical user interface only, and no messages exchanging between different instant messengers are made. Although such software provide an convenient and integrated environment, but all of the same attended interactions between instant messengers and the user are still necessary. Namely, a full-functioned integrated software of instant messengers is still not available. Unattended operations and more applications of sound messages or video messages in a full-functioned integrated environment of instant messengers are expected.

Network Phone (VoIP) is another way to exchange messages via the network. There are two application of the network phone. One of them uses traditional phones (Mobile phones are included), and the other uses computers and specific protocols. The later uses the sound interface to input or output sounds and transmits messages with the sounds in the specific protocols. The benefits of network phone is money saving for phone fees. However, it will be limited in some specific protocols or some programs for performing with these specific protocols. For coupling with the network and the traditional phones to provide more convenience, a communication apparatus can be used as an intermedium of the phones and the computers. Referring to FIG. 1C and FIG. 1D, a phone 18 is coupled with a computer 14 via a communication apparatuses 16 to construct a network phone. The network phone takes advantage of the network communication abilities of the computer 14 to communicate with other network phones. Or the communication apparatus 16 can be bundled with the network communication abilities and be coupled with a phone 18 to be a network phone. Besides, the communication apparatus 16 can also be integrated into the phone 18. The foregoing phone 16 is generally known as the audio frequency apparatus and employed as a media for transmitting audio. Moreover, the audio frequency apparatus transmits audio via wired or wireless network and are contingent to have the phone-like shape.

Accordingly, less phone fees and more convenience can be made if the advantages of the network phone an instant messengers can be used and the limitation of them can be eliminated.

### SUMMARY OF THE PRESENT INVENTION

Another main purpose of the present invention is to provide an instant messenger extension for cross instant messengers. By using such an instant messenger extension for nowadays instant messengers, different instant messengers can communicate to each other. The communication is not limited in some specific instant messengers.

Still another main purpose of the present invention is to provide a remote controlled instant messenger extension for providing ambiguous and unattended operation.

According to the purposes described above, the present invention provides an instant messenger extension for cross instant messengers. The instant messenger extension includes a message monitor to filter the messages of nowadays instant messengers. For providing an interface extension of a communication apparatus, messages exchanging extends between the communication and remote instant messengers via the local instant messengers. The communication apparatus can further communicate with other remote communication apparatuses to providing them to exchange messages by the communication between instant messengers. Thus, the usage of the instant messengers can be unattended and ambiguous.

### BRIEF DESCRIPTION OF THE DRAWINGS

FIG. 1A to FIG. 1D are diagrams of the prior arts.

FIG. 2A AND FIG. 2B are function block diagrams of the embodiment of the present invention.

FIG. 3 is a function block diagram of another embodiment of the present invention.

FIG. 4 is a function block diagram of further embodiment of the present invention.

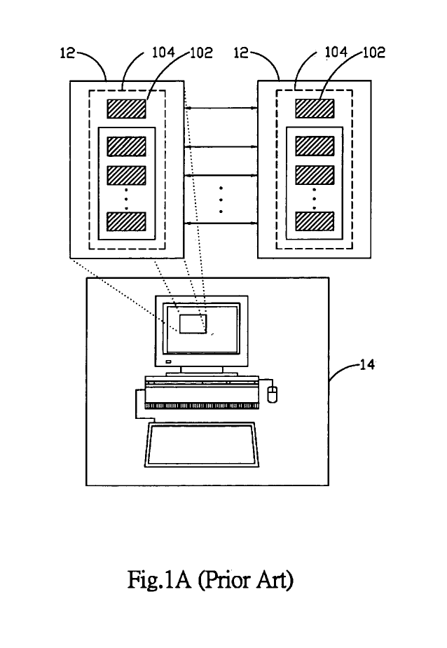

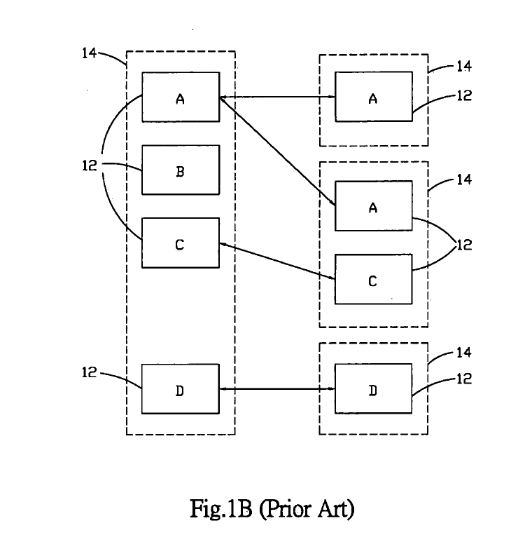

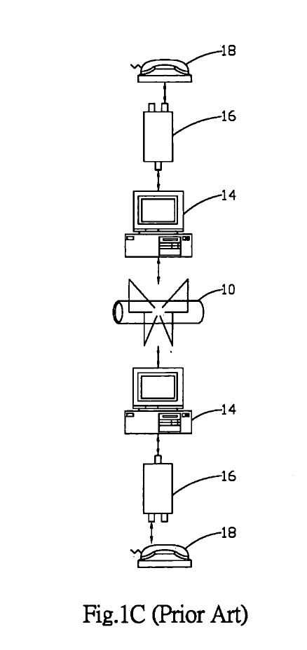

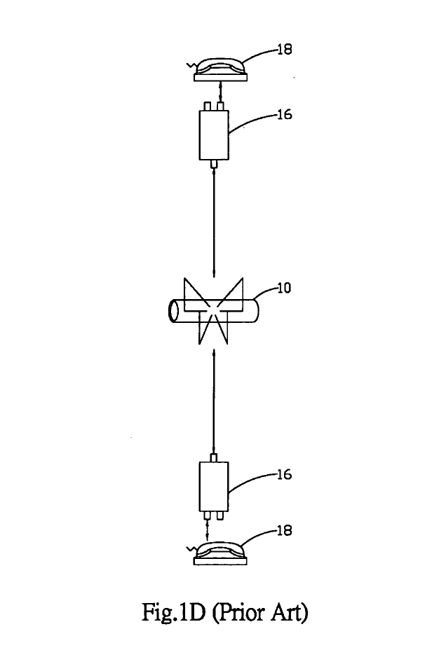

### DETAIL DESCRIPTION OF THE PREFERRED EMBODIMENT

Instant messengers can be installed on a digital electrical apparatus (i.e. personal computer, PDA, router or the like) to transform information contents from the local peripherals of the digital electrical into messages and to transmit them to remote instant messengers on remote digital electrical apparatuses via network. Similarly, messages from remote instant messengers can be played or displayed on the local peripherals by the local install messenger. For example, the sounds received by the sound interface can be sent to remote instant messengers by the local instant messengers, or sounds contents within the messages from the remote instant messengers can be sent to the sound interface for displaying. Moreover, an instant messenger may handle different information contents, such as video, audio, text, files or the like. The input and the output are different information contents are handled by different peripherals. On these grounds, instant messengers can transform different information contents from different peripherals into different type of messages or recoveries different information contents of different peripherals from different type messages. Each type of information contents may be inputted or outputted by one or more peripherals with similar functionality simultaneously. Furthermore, information contents may be switched to input or to output via a group chosen from the proper peripherals. The most common way is to input or to output the information contents according the default setting of the operating system. Thus, the easiest way to switch the peripherals for inputting or outputting is to change the default setting of the operating system. For instance, the default setting for text can be assigned from the monitor to a file (such as a history file of an instant messenger). By way of it, similarly, the output of a sound file can be assigned to the sound interface. Moreover, extra work can be made to gather the same type information contents from or to more than one peripheral. Thus the input and the output of information contents can be redirected by changing the setting of operating system or instant messengers. Accordingly, the redirection for information contents described in the following including the foregoing manners.

The original designs of instant messengers for inputting information contents are for manual operations by users or automatic operations by peripherals. For examples, mouse clicking, keyboard keying in, or the control of other peripherals interacting with users. Then a specific function is executed after a series of operations. The series of operations can be considered as a specific operation (or a macro). Most specific operations are routines, so such specific operations can be covered by or pre-recorded in a macro or a program.

Moreover, messages exchanging can be considered as a communication. The communication can be unidirectional or bi-directional. Instant messengers may have to perform some procedure during communication. For examples, a communication may have to complete handshaking before it is constructed if the security is concerned. Namely, the peer that asks for communication must acquire the acceptation from another peer to construct the communication. Of course, the communication won't construct or destroyed if the response of rejection or a notice of disconnection is received. The request, acceptation, rejection, disconnection or the like are contained in messages within the communication between instant messengers. Thus, some key message segments corresponding to them can be found and defined. Accordingly, messages monitoring in accordance with these key message segments can recognize some messages that contain these special meanings. These key message segments can be text segment, file segment, audio segment, video segment or the like, and the manners for monitoring may be string filtering, file certification, audio recognition, video recognition or the like respectively. The present invention does not limit the manner for monitoring.

Accordingly, the present invention presents an instant messenger extension for providing a extent interface of instant messengers with communication apparatuses. Moreover, the communication apparatuses can communicate with remote communication apparatuses via communication network to provide unattended operations. For examples, the combination of phones and instant messengers can make conversations possible on Internet. Furthermore, users can use a phone to communicate with the phone connected to the instant messenger extension for providing unattended and ambiguous operation and communication.

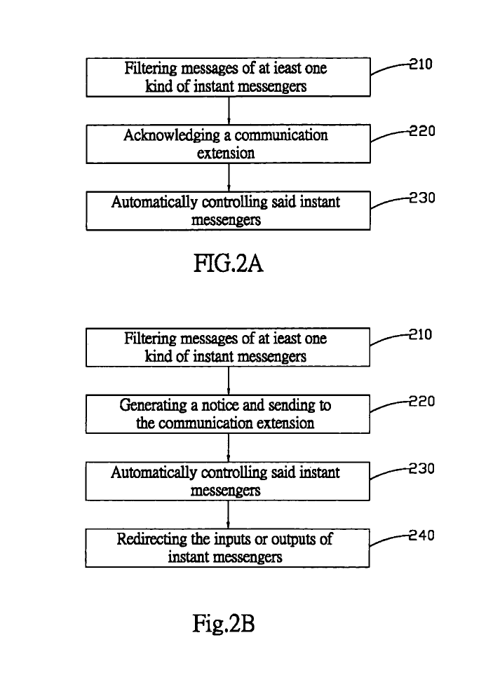

Thus, one preferred embodiment of the present invention is a method for instant message extension. Referring to FIG. 2A, firstly, step 210 filtering the message of at least one kind of instant messenger. That is, monitoring messages of instant messengers by the manners described above to filter out the messages contained key message segment. The type of messages, instant messengers and manners for filtering key message segments are not limited in the present invention. Then step 220 acknowledges a communication extension by using a notice. The communication extension can be considered as the extend user interface of instant messengers. That is, an extra user interface is provided outside the instant messengers. Moreover, the notice is generated and sent when key message segments within a message or messages are recognized. The foregoing notice can be a request, an order, or an instruction for other external apparatuses. Furthermore, instant messengers can be automatically controlled as shown in step 230. The instant messengers are automatically controlled by a signal generated by the communication extension according to the notice.

Hence, communication extension may be asked to respond or to execute some functions when the local instant messenger receives a message contained the above mentioned key message segment. The manner for responding can be sending a signal, a message, a remote procedure call and so on. The present invention does not limit the manner for responding. When the key message segment is a request that means some kind invention (such as audio exchanging, video exchanging, file transmission or so forth), the communication extension must respond an acceptation or a rejection. Besides, a time out response may be responded because of no answer after a default time threshold. Such a time out response can be considered as a rejection.

Furthermore, the communication extension can include some inputs or outputs for some information contents for providing extran inputs or outputs of instant messengers. Referring to 2B, step 240 can further redirect the inputs or outputs of instant messengers. That is, some inputs or outputs of instant messengers can be assigned to the inputs and outputs of the communication extension. For instance, after redirecting, an audio input of the communication may become the audio input of an instant messenger, and the sounds received by the audio input of the communication will be transformed into messages and sent to other instant messages. These information contents handled by the inputs and the outputs can be text, file, audio, video or the like. Moreover, an input or a output can be assigned to be the input or output of one or more instant messengers. That is, an information contents received by a local instant messenger can be received by other local instant messengers, thus cross instant messengers communication can be performed. In the present invention, the manner of redirection will not be limited.

The communication extension can not only respond passively, but also actively send a request to instant messengers, applications, operating system, other software or hardware. For examples, the communication extension can request a shut down signal to the operating system. This can be designed for automatically controlling the instant messengers, other software or hardware. The automatically controlling can be above-mentioned manner for executing a specific operation, automatically answering or responding, or other convenient manners to replace the operation of users.

Moreover, the inputs or outputs of the communication extension can be provided from the hardware or software connected to it. The hardware or software can be audio or video apparatuses, communication apparatuses or the remote apparatuses for communicating with the communication apparatuses, the input or output emulated by software, or other hardware for inputting or outputting. For examples, the communication extension can include at lease a communication apparatus. The input or output of the communication apparatus can be used for the input or output of one or some instant messengers. The communication apparatus can communicate with a remote communication apparatus via the telecommunication network. Then the input or output of the remote communication apparatus can also be used to be the input or output of the instant messengers. Besides, the communication apparatus can include a user interface for interacting with users to generate the above mentioned signal. The above-mentioned signal can also be generated according to the interaction with the user caused by operating the user interface of the communication apparatus.

Therefore, the communication apparatus can prompt the user to respond when a notice is received if the notice means to request a response. The manner for prompting can be ringing, lightening or so forth. If the user answers the request, the communication extension responds a signal. Besides, the communication extension can automatically responds a signal when no answer from users after time out. The signal can be above mentioned acceptation (answered by users), rejection (answered by users), disconnection (answered by users or automatically generated), time out (automatically generated) or the like. For examples, the communication can be a phone or an answering machine. When a request arrives, a acceptation is responded if the user answers the phone or the answering machine automatically answers. Of course, the user can reject the request by some kind operation or just hang up the phone, and then a rejection or disconnection would be responded separately. Moreover, the communication extension can control the communication apparatus to call a remote communication apparatus via telecommunication network. The foregoing acceptation, rejection, disconnection can be responded according to the operation that user made with the remote communication apparatus. The remote communication apparatus can be a phone, mobile phone, modem, fax machine, answer machine and so on.

Accordingly, another preferred embodiment of the present invention is an instant messenger extension system. In the preferred embodiment, an instant messenger monitor for monitoring the messages of one or more instant messengers and a foregoing communication extension are used. The instant messenger monitor can use to perform above-mentioned filtering messages of at least one kind of instant messengers (step 210), acknowledging a communication extension (step 220) and automatically controlling said instant messengers (step 230). Thus, the preferred embodiment can be used for widespread extension of instant messengers. By connecting to the communication apparatuses, the instant messengers can have the ability for unattended and ambiguous operation.

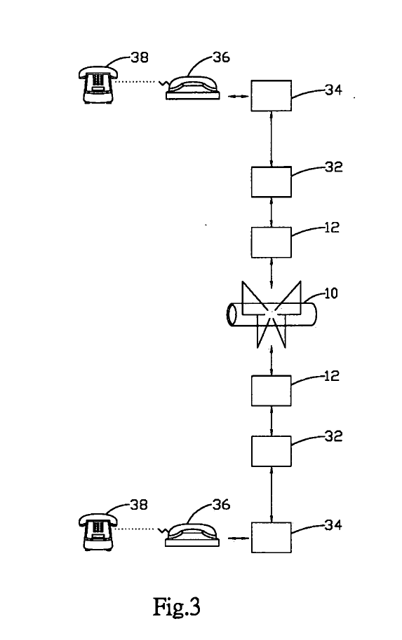

FIG. 3 is a diagram of the instant messenger extension system in the preferred embodiment. The communication apparatus 36 and the remote communication apparatus 38 can be a phone (such a telephone, mobile phone or so on.), answering machine, modem, fax machine or the like. Besides, the communication apparatuses can also be an ASIC built in the communication extension or any communication apparatuses connected to telecommunication network (such as a modem). The communication apparatuses are used for communicating or exchanging information contents, the sort or type of the communication apparatuses does not limited in the present invention. For instance, the phone (or the communication apparatus 36) prompts (such as ringing) when the communication extension 34 receives the above-mentioned request, and the above mentioned signal will be responded when the phone is answered (i.e. the telephone transmitter is picked up). Besides, the phone can be used for sending signals by dialing. For examples, generate a specific signal by a specific number dialing, instant messenger 12 will be automatically controlled to construct a communication with a specific remote instant messenger 12. The specific number dialing can also be done by following the instructions of the voice response. Moreover, the communication extension 12 can control the communication apparatus 36 to dial a phone number according the message contained a key message segment and the phone number corresponding to a remote communication apparatus 38.

In accordance with the present invention, the design of the connection with the communication extension and the communication apparatuses make the usage of instant messengers more convenient and simpler. Namely, users can use an instant messenger to control the communication apparatuses and vice versa. Therefore a further preferred embodiment of the present invention is an instant messenger extension system that includes a communication extension. Comparing to the prior embodiment, the preferred embodiment requests the communication extension a response when some events are triggered and does not need to monitor messages of instant messengers. Besides, the communication extension can control instant messengers directly. Furthermore, the input and output provided by the communication extension can be assigned directly to be the input and output of instant messengers. Therefore, there is no redirection needed during messages exchanging. The only differences between the preferred embodiment and the prior embodiment are no messages monitoring and redirection in the preferred embodiment. Hence, no redundant detail is described herein.

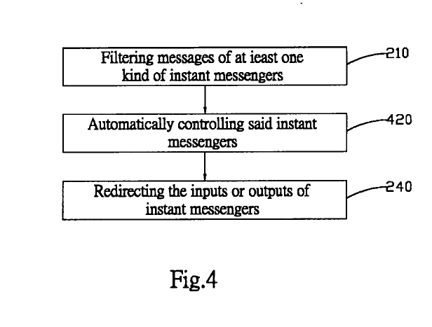

Accordingly, the still further preferred embodiment of the present invention is an instant messenger extension. Referring to FIG. 4, firstly as the description of step 210, monitoring and filtering the messages of at least one instant messenger. Then automatically responding to each request within messages from the instant messengers, referring to step 420. The foregoing automatically responding is triggered when a key message segment is filtered out in the step 210. Next, as described in step 240, redirect the input and the output of said instant messengers. Each key message segment corresponds to a predefined above-mentioned specific operation to be a reaction for the above mentioned automatically responding. For examples the specific operation is to respond an acceptation when the request means to ask a communication for exchanging messages, and message exchanging begins after said automatically responding. Furthermore, the redirection of the input or output can be made before or after the above mentioned automatically responding. The inputs and outputs of instant messenger can be assigned to files. Moreover, the key message segment can be transform into request to external apparatuses, and the automatically responding can be made according to the response from the external apparatuses. By redirecting to files, the present invention can record the incoming informing contents. The preferred embodiment can further add automatic voice (video) response to having the abilities of automatic voice response, automatic video response, automatic file receiving and transmission, automatic fax receiving and transmission and so on.

According to the design of the present invention, users can use wired/wireless communication apparatuses (such as phone or mobile phone) to remote control instant messengers running on a digital apparatuses, whereby the unattended and ambiguous message exchanging between instant messengers is available. The foregoing instant messengers include Windows Messenger, MSN Messenger, AIM, Yahoo Messenger, ICQ or the like. By automatically responding with a specific operation, remote software controlling are also available.

What are described above are only preferred embodiments of the invention, not for confining the claims of the invention; and for those who are familiar with the present technical field, the description above can be understood and put into practice, therefore any equal-effect variations or modifications made within the spirit disclosed by the invention should be included in the appended claims.

1. An instant messenger extension, including:
filtering messages of at least one kind of instant messengers;
acknowledging a communication extension, wherein said communication extension is acknowledged by a notice and said notice is generated when said messages are filtered by a key message segment; and
automatically controlling said instant messengers, wherein said instant messengers is automatically controlled by a signal generated according to said notice.

2. The instant messenger extension according to claim 1, wherein the way for messages filtering is chosen from the following group comprising voice recognition, image recognition and data filtering.

3. The instant messenger extension according to claim 1, wherein said notice is a request, said signal is the response for said request.

4. The instant messenger extension according to claim 1, wherein said signal is an order for controlling said instant messengers from said communication extension.

5. The instant messenger extension according to claim 1, further including forwarding the output of said communication extension to become the output of said instant messengers.

6. The instant messenger extension according to claim 1, further including forwarding the input of said communication extension to become the input of said instant messengers.

7. The instant messenger extension according to claim 1, wherein said communication extension comprises at least a communication apparatus.

8. The instant messenger extension according to claim 7, wherein the input and the output of said communication apparatuses is the input and the output of said communication extension.

9. The instant messenger extension according to claim 7, wherein said communication apparatuses comprises a user interface for providing interaction and said signal is generated according to the interaction.

10. The instant messenger extension according to claim 9, wherein said communication apparatuses is a phone and said signal orders said instant messengers to send messages for requesting.

11. The instant messenger extension according to claim 9, wherein said notice means asking for a response and said communication apparatuses rings when said communication extension receives said notice, afterward, said communication apparatuses responses for said notice when said communication is at a communication status, wherein said communication status is at the duration that the input and the output of said communication apparatuses becomes the input and the output of said communication extension.

12. The instant messenger extension according to claim 11, wherein said communication apparatuses is a phone, said phone rings when said communication extension is asked for a request and responses said signal when said phone is answered, wherein said signal means accepting said request.

13. The instant messenger extension according to claim 7, wherein said communication extension is further electrically coupling with a communication network to provide for communicating with at least a remote communication apparatuses.

14. The instant messenger extension according to claim 13, wherein said remote communication apparatuses includes a user interface to providing interaction and said signal is generated according to the interaction.

15. The instant messenger extension according to claim 14, wherein said remote communication apparatuses is a phone and said signal orders said instant messengers to send messages for requesting.

16. The instant messenger extension according to claim 13, wherein said communication network is electrically coupling with said communication apparatuses and the output and input of said remote communication apparatuses becomes the output and input of said communication apparatuses when said communication apparatuses communicates with said remote communication apparatuses.

17. The instant messenger extension according to claim 16, wherein said notice means asking for a request and said communication apparatuses asks said remote communication apparatuses for communication when said notice is received.

18. The instant messenger extension according to claim 17, wherein said remote communication rings when said notice is received and said responses for said notice when said communication is at a remote communication status, wherein said remote communication status is at the duration that the input and the output of said remote communication apparatuses becomes the input and the output of said communication extension.

19. The instant messenger extension according to claim 18, wherein said remote communication apparatuses is a phone, said phone rings when said communication extension is asked for a request and responses said signal when said phone is answered, wherein said signal means accepting said request.

20. An instant messenger extension system, including:
a communication extension; and
an instant messenger monitor for monitoring the messages of at least one kind of instant messengers, wherein said instant messenger monitor generates a notice and send said notice to said communication extension when said messages are filtered by a key message segment, and controls said instant messengers which are monitored according a signal sent by said communication extension.

21. The instant messenger extension system according to claim 20, wherein the way for messages filtering is chosen from the following group comprising voice recognition, image recognition and data filtering.

22. The instant messenger extension system according to claim 20, wherein said notice is a request, said signal is the response for said request.

23. The instant messenger extension system according to claim 20, wherein said communication extension outputs at least one kind of information contents and the output of said communication extension is forwarded to the remote instant messengers via the output of said instant messengers by said instant messenger monitor.

24. The instant messenger extension system according to claim 20, wherein said communication extension receives at least one kind of information contents and the output of the remote instant messengers is forwarded to the input of said communication extension via the input of said instant messengers by said instant messenger monitor.

25. The instant messenger extension system according to claim 20, wherein said communication extension includes at least a communication apparatus.

26. The instant messenger extension system according to claim 25, wherein the output of at least one kind of information contents from said communication apparatuses is assigned as the output of said communication extension.

27. The instant messenger extension system according to claim 25, wherein the input of at least one kind of information contents from said communication apparatuses is assigned as the input of said communication extension.

28. The instant messenger extension system according to claim 25, wherein said communication apparatuses electrically couples with a communication network and communicates with a remote communication apparatuses via said communication network.

29. The instant messenger extension system according to claim 25, wherein said remote communication apparatuses communicates with said communication apparatuses and the input and the output are assigned to be the input and the output of said communication extension respectively after said communication apparatuses is asked for communication by said remote communication apparatuses.

30. The instant messenger extension system according to claim 25, wherein said signal is generated according the messages from said remote communication apparatuses when said remote communication apparatuses starts to communicate with said communication apparatuses.

31. An instant messenger extension system, include:
a communication extension; and
a control interface for controlling at least one instant messenger, wherein said control interface and said communication extension are mutually controlled by each other, and the input and the output of messages are forwarded from one to another between said communication extension and said instant messengers.

32. The instant messenger extension system according to claim 31, wherein the contents of said messages are chosen from the following group comprising sound, image and data.

33. The instant messenger extension system according to claim 31, wherein said communication extension includes at least one communication apparatus.

34. The instant messenger extension system according to claim 33, wherein said communication apparatuses comprises a user interface for providing interaction and said instant messengers are controlled by the interaction.

35. The instant messenger extension system according to claim 33, wherein said communication apparatuses and said communication extension are mutually controlled by each other and the input and the output of messages are forwarded from one to another between said communication apparatuses and said instant messengers.

36. The instant messenger extension system according to claim 35, wherein said communication apparatuses is a phone.

37. The instant messenger extension system according to claim 33, wherein said communication apparatuses is further electrically coupled with a communication network and communicates with at least one remote communication apparatuses via said communication network.

38. The instant messenger extension system according to claim 37, wherein said remote communication apparatuses and said control interface are mutually controlled by each other via said communication extension, and the input and the output of messages are forwarded from one to another between said remote communication apparatuses and said instant messengers.

39. The instant messenger extension system according to claim 37, wherein said remote communication apparatuses is a phone.

40. An instant messenger extension, include:
monitoring and filtering at least one kind of instant messengers;
automatically responding to each request within messages from said instant messengers, wherein said request is responded after a key message segment corresponding to said request is filtered out; and
redirecting the input and the output of said instant messengers.

41. The instant messenger extension according to claim 40, wherein the contents of said messages are chosen from the following group comprising sound, image and data.

42. The instant messenger extension according to claim 40, wherein said request means asking for message interchanging.

43. The instant messenger extension according to claim 42, wherein said message interchanging starts when an acceptation is automatically responded to said request.

44. The instant messenger extension according to claim 42, wherein said the input and the output of said instant messengers are redirected after the request is responded.

45. The instant messenger extension according to claim 42, further including message interchanging between different kinds of instant messengers.

46. The instant messenger extension according to claim 45, wherein said message interchanging between different kinds of instant messenger is to forward the incoming messages to other kind instant messengers by redirecting the input and the output of said instant messenger.

47. The instant messenger extension according to claim 40, wherein said automatically responding is made after a external signal is arrived and said external signal is responded according to said key message segment.

48. The instant messenger extension according to claim 40, further including automatically controlling said instant messenger to replace the interaction between the users and said instant messengers.

49. The instant messenger extension according to claim 40, wherein the input and the output of said instant messengers are redirected to a file.
